(19) United States
(12) Patent Application Publication
(10) Pub. No.: US 2024/0218125 A1
(43) Pub. Date: Jul. 4, 2024

(54) AMIDOAMINE COMPOSITION AND ADHESIVE COMPOSITION CONTAINING THE SAME

(71) Applicant: Evonik Operations GmbH, Essen (DE)

(72) Inventors: Zhenlong YAN, Shanghai (CN); Keiji WAKITA, Chiba (JP); Limin ZHOU, Shanghai (CN)

(73) Assignee: Evonik Operations GmbH, Essen (DE)

(21) Appl. No.: 18/287,607

(22) PCT Filed: May 14, 2021
(86) PCT No.: PCT/CN2021/093881

§ 371 Date: Oct. 19, 2023

(51) Int. Cl. C08G 73/02; C09J 127/06; C09J 163/00

(52) U.S. Cl. CPC C08G 73/028; C09J 127/06; C09J 163/00

(57) ABSTRACT

Provided are an amidoamine composition, an adhesive composition comprising the amidoamine composition, and a method for preparing the amidoamine composition. The amidoamine composition contains a polyamidoamine and an ammonium salt of an aminosilane or a mercaptosilane.

### TECHNICAL FIELD

The present disclosure relates to an amidoamine composition, an adhesive composition containing the same, and a method for preparing the amidoamine composition.

### BACKGROUND ART

Due to more stringent environmental regulations, particularly those with respect to controlling volatile organic compounds (VOC) emission and achieving carbon neutrality, new energy vehicles, especially electronic vehicles (EVs), are in high demand. To achieve a high range for a given battery size and weight, weight reduction of EVs is needed. Currently, aluminum is the preferred material of choice among engineers and designers. Inside various EVs, light weight aluminum alloys are candidates to substitute for carbon steel with cathode electrode deposition (CED) coating to save energy and improve corrosion resistance. Since there is no CED coating, it would be very difficult for traditional polyvinyl chloride (PVC) plastisol to directly bond on the surface of aluminum alloys. There is a high demand for adhesives and coatings capable to strongly bond to the surface of aluminum alloy parts.

The following published patent applications disclosed epoxy 2K (two components) compositions and their good adhesion on aluminum alloy surface for adhesive or ink coating application.
Published patent application 1: EP3317329A1
Published patent application 2: EP1885764A1

In this disclosure, provided is an amidoamine composition, which, after being mixed with a PVC plastisol or an epoxy resin, could achieve an improved adhesion to metal surfaces. Also provided are an adhesive composition containing the amidoamine composition, as well as a method of preparing the amidoamine composition.

### SUMMARY

One objective of the present disclosure is to provide an amidoamine composition, which, when combined with a curable polymeric composition, can realize strong adhesion to metal surfaces such as aluminum alloy surfaces.

This objective of the present disclosure is achieved by providing an amidoamine composition comprising: i) an amidoamine with a) at least one amide group or at least one imide group; and b) at least one amino group; and ii) one or more silanes selected from the group consisting of: c) an ammonium salt of an aminosilane, the aminosilane being represented by formula (I):

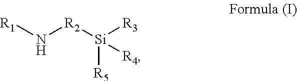

and d) a mercaptosilane represented by formula (II):

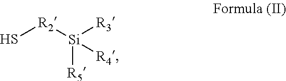

wherein, R₁ is a hydrogen atom, an alkyl group, a substituted alkyl group, an aryl group, or a substituted aryl group; R₂ and R₂′ are independently an aliphatic chain with at least one carbon atom; R₃, R₃′, R₄, R₄′, R₅ and R₅′ are independently an alkyl group with 1 to 20 carbon atoms, an alkoxy group with 1 to 20 carbon atoms, or an aryloxy group with 6 to 20 carbon atoms.

Preferably, R₁ has at least one nitrogen atom in the form of —NH₂, —NHR₆, or —NR₇R₈, wherein R₆, R₇, and R₈ are independently an alkyl group, a substituted alkyl group, an aryl group, or a substituted aryl group.

Preferably, R₃, R₃′, R₄, R₄′, R₅, and R₅′ are independently selected from methyl, ethyl, propyl, butyl, methoxy, ethoxy, propoxy, butoxy, or 2-(2-butoxyethoxy)ethoxy.

Preferably, the amidoamine is a reaction product of a) one or more carboxylic acids and b) one or more amines with at least two amino groups.

Preferably, the carboxylic acids include a dicarboxylic acid.

Preferably, the amines include one or more polyalkylenepolyamines.

Preferably, the amidoamine is a reaction product of a) one or more amines having a terminal primary amino group and b) one or more copolymers of an alpha-olefin and an unsaturated carboxylic anhydride.

Preferably, the amines include one or more selected from aminomethylpiperazine, aminoethylpiperazine, aminopropylpiperazine, aminomethylimidazolidine, aminoethylimidazolidine, aminopropylimidazolidine, dimethylaminopropylamine, or dimethylaminopropylaminopropylamine.

Preferably, the alpha-olefin is an alpha-olefin having 2 to 20 carbon atoms.

Preferably, the unsaturated carboxylic anhydride is selected from maleic anhydride, itaconic anhydride, or citraconic anhydride.

Preferably, the amidoamine composition further comprises an organic chloride.

Another objective of the present disclosure is achieved by providing an adhesive composition comprising: 1) an amidoamine composition; and 2) a curable polymeric composition.

Preferably, the curable polymeric composition includes poly(vinyl chloride) or a vinyl chloride copolymer.

Preferably, the curable polymeric composition includes an epoxy polymer.

Preferably, the adhesive composition further comprises a plasticizer.

Preferably, the adhesive composition further comprises one or more additives selected from fillers, reinforcing agents, adhesion promoters, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, anti-dripping agents, stabilizers, metal glitters, metal coated particles, porosity inducers, glass fibers, nanoparticles, flow assistants, or combinations thereof.

Preferably, the additive has a weight percentage of less than 90%, based on a total weight of the adhesive composition.

Preferably, the amidoamine composition has a weight percentage of less than 10%, based on a total weight of the adhesive composition.

Preferably, the amidoamine composition has a weight percentage of more than 0.5% and less than 5%, based on a total weight of the adhesive composition.

Another objective of the present disclosure is achieved by providing a method for preparing an amidoamine composition, comprising: i) providing an amidoamine with a) at least one amide group and b) at least one amino group; ii) providing one or more silanes selected from the group consisting of c) an ammonium salt of an aminosilane, the aminosilane being represented by formula (I);

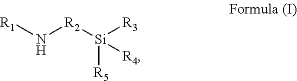

and
d) a mercaptosilane represented by formula (II):

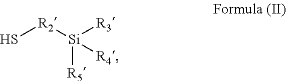

and iii) mixing the amidoamine and the one or more silanes and forming the amidoamine composition, wherein, R₁ is a hydrogen atom, an alkyl group, a substituted alkyl group, an aryl group, or a substituted aryl group; R₂ and R₂′ are independently an aliphatic chain with at least one carbon atom; R₃, R₃′, R₄, R₄′, R₅, and R₅′ are independently an alkyl group with 1 to 20 carbon atoms, an alkoxy group with 1 to 20 carbon atoms, or an aryloxy group with 6 to 20 carbon atoms.

Compositions in the present disclosure provide PVC plastisol or epoxy system with excellent properties of strong bonding to metal surfaces, which is suitable for many applications in electric vehicle.

### DETAILED DESCRIPTION

The following description is used merely for illustration but is not to restrict the scope of the present disclosure.

The term “amidoamine” refers to a family of organic compounds that contains at least one amido or imido group in its backbone, besides at least one amino group. The amino group could be a primary amino group —NH₂, a secondary amino group —NHR_{A}, or a tertiary amino group —NR_{B}R_{C}, wherein R_{A}, R_{B}, and R_{C} are independently hydrocarbon radical groups. Amidoamines can serve as curing agents for various polymeric composition, for example, epoxy resins.

The term “mercaptosilane” refers to a family of silanes that have at least one mercapto group attached directly or indirectly to the silicon atom through a carbon chain. Traditionally, mercaptosilanes are widely used coupling agents for silica-based materials because of their bifunctional nature. Without limitation, known mercaptosilanes include (3-mercaptopropyl)-triethoxysilane and (3-mercaptopropyl)trimethoxysilane.

The term “aminosilane” refers to a family of silanes that have at least one amino group attached directly or indirectly to the silicon atom through a carbon chain. Traditionally, aminosilanes are widely used coupling agents for silica-based materials because of their bifunctional nature. Without limitation, known aminosilanes include (3-aminopropyl)-triethoxysilane, (3-aminopropyl)-diethoxy-methylsilane, (3-aminopropyl)-dimethyl-ethoxysilane, (3-aminopropyl)-trimethoxysilane, (3-(aminoethylamino)propyl)-trimethoxysilane, (3-(aminoethylamino)propyl)-methyldimethoxysilane, (3-(aminoethylamino)propyl)-triethoxysilane.

Herein the term “plastisol” refers to a suspension of polyvinyl chloride (PVC) or other polymer particles in a liquid plasticizer. The plastisol flows as a liquid and can be poured into a heated mold. When heated to a certain temperature or temperature range, the plastic particles dissolve and the mixture turns into a gel of high viscosity that can no longer be poured. Plastisol is commonly used as a coating.

### Amidoamine

According to the present disclosure, the amidoamine has at least one amido or imido group and at least one amino group. The amidoamine could be prepared by reacting a carboxylic acid with at least one amine with at least two amino groups. Alternatively, the amidoamine could be prepared by reacting an anhydride-based copolymer with at least one amine having a terminal primary amino group.

The reaction could be carried out in a non-aqueous medium under an elevated temperature. The mixture of carboxylic acid and/or anhydride and polyamine preferably is stirred vigorously to achieve a homogeneous distribution of reactants. An inert atmosphere is preferably applied so as to prevent or suppress oxidation or side reactions. After several hours of condensation, an evaporation was conducted to remove water as one of the reaction products.

The stochiometric ratio of the carboxylic groups in the carboxylic acid and/or the anhydride of carboxylic acid to the amino groups in the polyamine is such that nearly all the carboxylic groups and the anhydride groups are exhausted while a considerable quantity of amino groups remain unreacted. The unreacted amino groups in the resultant is essential to promotion of adhesion of polymeric compositions including PVC plastisol or epoxy resins to metal surfaces.

### Carboxylic Acids

Carboxylic acids used herein refers to an organic acid with one or more carboxylic groups. The carboxylic groups could react with amino groups in amines and form amido moieties. The carboxylic acids include, without limitation to, a fatty acid, a hydrogenated fatty acid, a dimerized fatty acid, a hydrogenation product of dimerized fatty acid, a trimerized fatty acid, a hydrogenation product of trimerized fatty acid, or combination thereof. Preferably, the carboxylic acids include at least one dicarboxylic acid. More preferably, the dicarboxylic acid includes a dimerized fatty acid or a hydrogenated dimerized fatty acid. Still more preferably, the dimerized fatty acid or the hydrogenated dimerized fatty acid has 24 to 48 carbon atoms.

### Anhydride-Based Copolymer

Amidoamine could be prepared by reacting an anhydride-based copolymer with polyamine having a terminal primary amino group. The anhydride-based copolymer refers to a group of copolymers prepared by polymerizing an unsaturated monomer with an unsaturated anhydride. The anhydride-based copolymer contains reactive anhydride moieties, which can react with amines to form condensates containing imido groups.

Preferably, the unsaturated monomer contains at least one ethylenically unsaturated bond. More preferably, the unsaturated monomer is selected from an alpha-olefin, a (meth)acrylate, a (meth)acrylamide, a (meth)acrylonitrile, or any combination thereof.

More preferably, the alpha-olefin includes an alpha-olefin having 2 to 20 carbon atoms. Exemplary alpha-olefin includes ethylene, propylene, 1-butylene, 1-hexene, 1-octene, 1-decene, 1-dodecene, 1-tetradecene, 1-hexadecene, or 1-octadecene.

The unsaturated carboxylic anhydride is an anhydride of an unsaturated dicarboxylic acid. Preferably, the unsaturated carboxylic anhydride is one or more selected from maleic anhydride, itaconic anhydride, or citraconic anhydride.

Exemplary anhydride-based copolymers include polyethylene-graft-maleic anhydride, maleic anhydride-grafted polypropylene, styrene-maleic anhydride copolymer, maleic anhydride-methyl methacrylate copolymer, or maleic anhydride-acrylamide copolymer.

### Amine

The amines for preparing the amidoamine in the present disclosure include various diamines, triamines, tetraamines, or any combination thereof. The diamines include without limitation to acyclic or cyclic diamines. The acyclic diamines include without limitation to polyalkylamines, polyetheramines. The cyclic diamines include without limitation to alicyclic amines, aromatic amines, and amino-containing heterocycles.

Exemplary polyalkylamines are known, for example, ethyleneamines, propyleneamines, or substituted ethyleneamines such as ethylenediamine (EDA), diethylene triamine (DETA), triethylene tetraamine (TETA), tetraethylene pentaamine (TEPA), pentaethylene hexaamine (PEHA), N,N′-bis(3-aminopropyl)ethylenediamine, N,N″-bis(3-aminopropyl)diethylenetriamine, tris(2-aminoethyl)amine, aminoethylpiperazine, dipropylenetriamine, and tripropylenetetramine.

Polyetheramines are also known as poly(oxyalkylene) polyamines or amine-terminated polyethers. Exemplary polyetheramines are known, for example, those based on ethylene glycol, propylene glycol, glycerol, pentaerythritol, or combinations thereof. Commercially available polyetheramines could be purchased from various manufacturers, for example, as JEFFAMINE® D series polyetheramines from Huntsman Corporation.

Exemplary alicyclic amines are diamines or triamines with amino groups linked directly or indirectly to a non-aromatic carbon ring system. Commercially available alicyclic amines include without limitation to isomers of diaminocyclohexanes, isomers of bis(aminomethyl)cyclohexanes, 4,4′-methylenebiscyclohexanamine, bis(aminomethyl)norbornane, and isophorone diamine.

Exemplary aromatic amines are diamines or triamines with amino groups linked directly or indirectly to an aromatic ring system. Commercially available aromatic amines include without limitation to isomers of phenylenediamines, isomers of xylylenediamines, isomers of methylenedianilines, and 1,1′-biphenyl-4,4′-diamine.

Amino-containing heterocycles are known, for example, those having an aminoalkyl group attached to a nitrogen-containing heterocycle. The nitrogen-containing heterocycles includes without limitation to aziridine, azetidine, pyrrolidine, pyrrole, piperidine, azepane, azepine, azocane, azonane, azonine, diaziridine, diazetidine, imidazolidine, imidazole, pyrazolidine, pyrazole, triazole, diazinane, diazine, and triazinane. The aminoalkyl group refers to a saturated hydrocarbon radical having at least one hydrogen atom substituted by a primary, secondary, or tertiary amino group. Exemplary amino-containing heterocycles includes without limitation to aminomethylpiperazine, aminoethylpiperazine, aminopropylpiperazine, aminomethylimidazolidine, aminoethylimidazolidine, or aminopropylimidazolidine.

### Silane

The amidoamine composition provided in the present disclosure further includes one or more silanes selected from the group consisting of a) an ammonium salt of an aminosilane, the aminosilane being represented by formula (I):

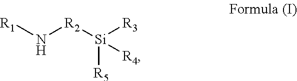

and b) a mercaptosilane represented by formula (II):

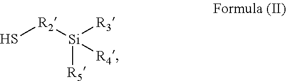

wherein, R₁ is a hydrogen atom, an alkyl group, a substituted alkyl group, an aryl group, or a substituted aryl group; R₂ and R₂′ are independently an aliphatic chain with at least one carbon atom; R₃, R₃′, R₄, R₄′, R₅, and R₅′ are independently a hydrocarbon radical with 1 to 20 carbon atoms, an alkoxy group with 1 to 20 carbon atoms, or an aryloxy group with 6 to 20 carbon atoms.

The hydrocarbon radical could be an alkyl, alkenyl, alkynyl, or aryl group. Preferably, the hydrocarbon radical is methyl, ethyl, propyl, butyl, pentyl, hexyl, cyclohexyl; vinyl, allyl; ethynyl; phenyl, tolyl, benzyl, 2-phenylethyl, xylyl, or naphthyl.

The alkoxy or aryloxy group refers to an organic group formed by removing a hydrogen atom from a hydroxyl group (—OH) in an alcohol or a phenolic.

The alcohol could be a monohydroxy alcohol, such as, methanol, ethanol, propanol, butanol, 2-methoxyethanol, 2-ethoxyethanol; a dihydroxy alcohol, such as, ethylene glycol, propylene glycol, polyethylene glycol, a trihydroxy alcohol, such as glycerol; or a polyhydroxy alcohol with four or more hydroxyl groups. Preferably, the alkoxy group is methoxy, ethoxy, propoxy, butoxy, or a group derived from a glycol monoether. The glycol monoether is an alkyl/aryl ether of a glycol, usually ethylene glycol or propylene glycol. Commonly used glycol monoether could include without limitation to 2-methoxyethanol, 2-ethoxyethanol, 2-propoxyethanol, 2-phenoxyethanol, 1-methoxy-2-propanol, diethylene glycol monomethyl ether, diethylene glycol monoethyl ether, diethylene glycol monopropyl ether, diethylene glycol monobutyl ether (also known as butyl diglycol), dipropylene glycol monomethyl ether, dipropylene glycol monoethyl ether, ethoxylated C12 alcohol, ethoxylated C13 alcohol, ethoxylated C14 alcohol, or ethoxylated C15 alcohol.

The phenolic could be phenol, 4-nonylphenol, xylenol, or bisphenol A. Preferably, the aryloxy group is phenoxy or aryloxy group.

R₃, R₃′, R₄, R₄′, R₅, and R₅′ preferably are methyl, ethyl, propyl, butyl, methoxy, ethoxy, propoxy, butoxy, or 2-(2-butoxyethoxy)ethoxy.

The mercapto group and the ammonium cation are known to possess good reactivity that is important to improve adhesion to metal surfaces.

Preferably, the silane is a mercaptosilane with at least one mercapto group (—SH). Exemplary mercaptosilanes are known, for example, 3-mercaptopropylmethyldimethoxysilane, (3-mercaptopropyl)trimethoxysilane (MPTMS), and (3-mercaptopropyl)-methyldimethoxysilane (MPDMS).

Preferably, the silane is an ammonium salt of aminosilane.

Preferably, in the ammonium salt of aminosilane, R₁ is a hydrogen atom, an alkyl group, a substituted alkyl group, an aryl group, or a substituted aryl group.

Preferably, the radical R₁ in the aminosilane could have at least one nitrogen atom. The nitrogen atom is present in the form of —NH₂, —NHR₆, or —NR₇R₈, wherein R₆, R₇, and R₅ are independently an alkyl group, a substituted alkyl group, an aryl group, or a substituted aryl group. In such case, the aminosilane has at least two amino groups.

The ammonium salt could be an ammonium salt of any known acid to skilled person. Preferably, the ammonium salt is a sulfate, a bisulfate, a nitrate, a perchlorate, a phosphate, a fluoride, a chloride, a bromide, an iodide, a formate, an acetate, an oxalate, a benzoate, etc.

The ammonium salt of aminosilane could be prepared by synthesis approaches known to a skilled person in the art. As an illustration, a hydrochloride of aminosilane with the aminosilane represented by formula (II) in the present disclosure was prepared by reacting a chlorohydrocarbon represented by formula (III) with an aminosilane represented by formula (IV).

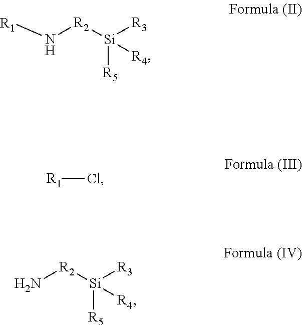

wherein, R₁ is a hydrogen atom, an alkyl group, a substituted alkyl group, an aryl group, or a substituted aryl group; R₂ is an aliphatic chain with at least two carbon atoms; R₃, R₄, and R₅ are independently a hydrocarbon radical with 1 to 20 carbon atoms, an alkoxy group with 1 to 20 carbon atoms, or an aryloxy group with 6 to 20 carbon atoms.

### Organic Chloride

In some embodiments, besides the amidoamine containing unreacted amino groups and silane, the amidoamine composition could further include at least one organic chloride. The organic chloride is preferably an alkyl chloride, an alkenyl chloride, an alkynyl chloride, or an aryl chloride, including, without limitation to, chloromethane, chloroethane, chloropropane, benzyl chloride, vinylbenzyl chloride, and xylylene dichloride.

The organic chloride could be added into the amidoamine composition in any suitable order. In some embodiments, the organic chloride was added into the newly prepared amidoamine to form a mixture. Then the silane was added into the mixture.

### Adhesive Composition

The amidoamine composition as provided in the present disclosure could be used as a coupling agent or an adhesion promoter in adhesive compositions, especially those based on PVC plastisol or epoxy resins.

Within the adhesive composition, the amidoamine composition has a weight percentage of preferably less than 10%, more preferably more than 0.5% and less than 8%, still more preferably more than 1% and less than 4%, based on a total weight of the adhesive composition.

Besides the amidoamine composition provided in the present disclosure, the adhesive compositions could include one or more curable polymeric compositions. Details regarding the curable polymeric compositions are described hereinafter.

### Curable Polymeric Composition

The adhesive composition includes a curable polymeric composition, which could vulcanize or harden if exposed to some factors, such as, moisture, light, heat, or curing agent. The curable polymeric composition preferably includes poly(vinyl chloride), a vinyl chloride copolymer, or an epoxy polymer. Although herein the term “polymeric” is used, the term “curable polymeric composition” could refer to prepolymers or oligomers as long as they can undergo polymerization or copolymerization to form cured/hardened materials.

Vinyl chloride copolymers are a family of copolymers having vinyl chloride as their monomer. The comonomer might be based on olefin, vinyl, (meth)acrylic or its derivatives, etc. Commonly known copolymers include copolymers of vinyl chloride and ethylene, propylene, styrene, vinyl acetate, vinyl alcohol, methyl (meth)acrylate, (meth)acrylamide, acrylonitrile, etc.

Epoxy polymers used herein are a family of polymers, prepolymer, oligomers having at least one epoxide group. Commercially available epoxy polymers are well known and could be purchased from various manufacturers in the brand names of, for example, Epon™, Epikure™, and Epikote™ from Hexion Inc., D.E.R.™ and D.E.N.™ from Olin Corporation.

### Other Components

The adhesive composition could include further components besides the amidoamine composition provided in the present disclosure and the curable polymeric composition.

In some aspects of the present disclosure, a plasticizer is included in the adhesive composition. The plasticizer could exist together with poly(vinyl chloride)/vinyl chloride copolymer particles in the PVC plastisol or with epoxy polymers in the epoxy resins. The plasticizer could be introduced by mixing of PVC plastisol/epoxy resins and the amidoamine composition of the present disclosure. Alternatively, the plasticizer could be added separately. In case several kinds of plasticizers are used, they preferably come from different classes of compound. Suitable plasticizers are all those commonly used for PVC. The plasticizers are preferably selected from the group consisting of phenolic esters, adipic esters, and butyric esters.

The amount of plasticizer in the adhesive composition of the present disclosure could vary very widely and is guided by the requirements of the case in hand, in particular by their plasticizing effect on the curable polymeric composition, such as PVC, vinyl chloride copolymers, or epoxy resins. The amount is preferably from 10 wt. % to 60 wt. %, more preferably from 15 wt. % to 50 wt. %, and in particular from 20 wt. % to 40 wt. %, based in each case on the total amount of the adhesive composition.

To bring in more functionality or features to satisfy industrial requirements, the adhesive composition preferably includes additives. Additives are understood to mean substances which are added to alter the properties of the adhesive composition in the desired direction, for example to match viscosity, wetting characteristics, stability, reaction rate, blister formation, storability, or adhesion, and use properties, to the end application. Several additives are described, for example, in WO 99/55772, pp. 15-25.

Preferred additives are selected from the group consisting of fillers, reinforcing agents, coupling agents, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, adhesion promoters, anti-dripping agents, metallic pigments, stabilizers, metal glitters, metal coated particles, porosity inducers, glass fibers, nanoparticles, flow assistants, or combinations thereof.

The additive preferably constitutes a proportion of not greater than 90 wt. %, preferably not greater than 70 wt. %, more preferably not greater than 50 wt. %, still more preferably not greater than 30 wt. %, with respect to the total weight of adhesive composition.

For example, it is advantageous to add light stabilizers, for example sterically hindered amines, or other auxiliaries as described, for example, in a total amount of 0.05% to 5% by weight.

To produce the adhesive compositions of the present disclosure, it is additionally possible to add additives such as levelling agents, for example polysiloxanes. In addition, still further components could optionally be present. Auxiliaries and additives used in addition could be chain transfer agents, plasticizers, stabilizers and/or inhibitors.

In some cases, the adhesive composition preferably includes an antioxidant additive. The antioxidant might include one or more of the structural units selected from sterically hindered phenols, sulfides, or benzoates. Here, in sterically hindered phenols, the two ortho-hydrogen atoms are substituted by compounds which are not hydrogen and preferably carry at least 1 to 20, particularly preferably 3 to 15, carbon atoms and are preferably branched. Benzoates also carry, preferably in the ortho position relative to the OH group, substituents which are not hydrogen and carry particularly preferably 1 to 20, more preferably, 3 to 15, carbon atoms, which are preferably branched.

In still another embodiment, if needed, one or more catalysts are preferably introduced to the adhesive composition, preferably as a part of the curing agent composition, to promote the reaction of the epoxide groups of epoxy resins and amine groups of the curing agent composition. Useful catalysts that could be introduced to the adhesive composition include Ancamine® products available from Evonik Operations GmbH and products marketed as “Accelerators” available from Huntsman Corporation. One exemplary catalyst is piperazine-base Accelerator 399 available from Huntsman Corporation. When utilized, such catalysts preferably comprise between 0 and about 10 percent by weight of the total adhesive composition.

Preferably, a curing accelerator could be added into the adhesive composition for speeding up the curing process when the adhesive composition is applied to a metal surface. The curing accelerator includes one or more selected from tris-(dimethylaminomethyl) phenol, benzyl dimethylamine, various isomers of nonyl phenols, triethanolamine, or N-(3-aminopropyl) iminodiethanol.

Other additives or ingredients could be present in the system depending on the end application or environment to which the adhesive composition is used.

Preferably, the adhesive composition according to the present disclosure comprises the above specified components.

Besides adhesives, the amidoamine composition provided in the present disclosure could find applications in many other fields, including without limitation to, coating, surface paint, protective films, sealants, filling materials, acoustic insulating materials, etc.

The present disclosure is illustrated by way of examples hereinbelow.

### EXAMPLES

In the following examples, the following materials were used.

Ancamine® 2655 was an aliphatic polyamine from Evonik (Shanghai) Specialty Chemicals Co., Ltd.

Jeffamine® D230 and Jeffamine® D400 from Huntsman Corporation were diamines with oxypropylene moieties. Jeffamine® T403 from Huntsman Corporation was a triamine with oxypropylene moieties.

Tetraethylene pentaamine (TEPA) as Ancamine® TEPA was from Evonik (Shanghai) Specialty Chemicals Co., Ltd.

Tetraethylene tetraamine (TETA) as Ancamine® TETA was from Evonik (Shanghai) Specialty Chemicals Co., Ltd.

2-(2-butoxyethoxy) ethanol (DGBE) was from Eastman (China) Co., Ltd.

Dimer acid was from Yihai Yuanda (Lianyungang) Co. Ltd.

Silane 1, a reaction product of 3-(triethoxysilyl)propanethiol and ethoxylated C13 alcohol, was from Evonik (Shanghai) Specialty Chemicals Co., Ltd. Silane 2, a hydrochloride of an aminosilane, was from Evonik (Shanghai) Specialty Chemicals Co., Ltd. Silane 3, a mercaptosilane, was from Evonik (Shanghai) Specialty Chemicals Co., Ltd.

Vinylbenzyl chloride was from Wuhan Organic Industry Co., Ltd.

Exxsol™ D80, a dearomatized aliphatic hydrocarbon solvent, was from ExxonMobil Chemical.

Diisopropyl naphthalene (DINP) was from Bluesail Group Co., Ltd.

VESTOLIT® P 1353 K was a PVC-homopolymer from Vestolit GmbH & Co. KG. VINNOLIT® SA 1062/7 was a vinyl chloride/vinyl acetate copolymer from Vinnolit GmbH & Co. KG. Lacovyl® PA 1384 was a vinyl chloride/vinyl acetate copolymer from ARKEMA S.A.

Socal® 312 was a coated chalk from Solvay Chemicals GmbH. Ulmer Weiss XM was a natural chalk from Eduard Merkle GmbH.

Aerosil® 200 was used as a thixotropic agent from Evonik Corporation.

CaO in the brand name Precal® 30S was a drying agent from Schaefer Kalk GmbH & Co. KG.

Zinc oxide from AppliChem GmbH was used as a stabilizer.

Exxsol™ D80 from Exxon Mobil Chemical Company was a dearomatized aliphatic hydrocarbon solvent.

The following protocols to test physical performance or properties of sample were used:

Viscosity was measured according to ASTM D445-83 by a Brookfield DV-II+Pro Viscometer at 25° C. Thin film set time (TFST) was measured using a Beck-Koller Drying Recorder, in accordance with ASTM D5895.

Amine value was measured on Mettler titrator according to ASTM D 2074 (perchloric Acid Titration).

Gardner color was measured according to ASTM D 1544-80.

Manual adhesion test method is described as below.

The PVC plastisol was applied to a clean metal substrate in a continuous ribbon measuring 8 cm long, 15 mm wide, and gradually increasing in thickness from 0 to 3 mm. The samples were baked in a convection oven based on baking circle. After baking, the samples were cooled to ambient temperature and two manual adhesion tests are performed. The first test was conducted after 1 hour from the end of baking. The second one was conducted after 24 hours from the end of baking. The adhesion measurement technique is described as follows. First, two parallel strips were cut at the thickest (3 mm) end of the plastisol ribbon. The strips were 1.5 cm apart. A scraper was inserted underneath the cut strip, cleanly separating the first 0.5 to 1 cm of the strip from the substrate. The loose hanging edge of the plastisol strip was then pulled away from the substrate. The first strip was pulled quickly, and the second was pulled slowly. Manual adhesion was evaluated in three categories based on the degree of force required to pull the plastisol strip from the substrate: excellent adhesion (great force), acceptable adhesion (intermediate force) or unacceptable adhesion (weak force).

### Synthesis Procedure

### Example 1

The synthesis was carried out in the following steps.

Step 1: A 2000 mL four-neck round-bottom flask was equipped with a vacuum line, a dropping funnel, a nitrogen outlet, and a stirrer. Into the flask was charged 460 g of dimer acid, 102 g of Ancamine® 2655, and 133 g of tetraethylene pentaamine (TEPA). The mixture was heated to 180° C. under agitation to remove water. The temperature was elevated to 250° C. and the reaction went on for 2 hours. Then the pressure was reduced by switching on the vacuum line and stopping the purge of nitrogen. Water was removed. The content was cooled to 100° C. Into the mixture, 60 g of 2-(2-butoxyethoxy) ethanol (DGBE) was charged. The mixture was stirred for 1 hour and then cooled to 70° C.

Step 2: 90 g of reaction product from Step 1 was charged into a flask and heated to 50° C., then 10 g of silane 1 in methanol was dropped within 30 minutes. The vacuum line was switched on to distill methanol. The mixture was discharged after agitation for 1 hour.

The typical properties of this finished product were as below: viscosity at 40° C., 22, 102 mPa·s; Gardner color 10; amine value, 302 mg KOH/g.

### Example 2

Step 1: A 2000 mL four-neck round-bottom flask was equipped with a vacuum line, a dropping funnel, a nitrogen outlet, and a stirrer. Into the flask was charged 460 g of dimer acid, 102.1 g of Ancamine® 2655, and 133.1 g of tetraethylene pentaamine (TEPA). The mixture was heated to 180° C. under agitation to remove water. The temperature was elevated to 250° C. and the reaction went on for 2 hours. Water was removed. Then the pressure was reduced by switching on the vacuum line and stopping the purge of nitrogen. The content was cooled to 100° C. Into the mixture, 100 g of diisopropyl naphthaline (DINP) was charged. The mixture was stirred for 1 hour and then cooled to 70° C.

Step 2: 95 g of reaction product from Step 1 was charged into a flask and heated to 50° C., then 10 g of silane 1 in methanol was dropped within 30 minutes. The vacuum line was switched on. The mixture was discharged after agitation for 1 hour.

The typical properties of this finished product were as below: viscosity at 40° C., 35,890 mPa·s; Gardner color 12; amine value, 286 mg KOH/g.

### Example 3

Step 1: All synthesis process is the same as Step 1 in Example 1.

Step 2: 90 g of reaction product from Step 1 was charged into a flask and heated to 50° C., then 10 g of silane 2 in methanol was dropped within 30 minutes. The vacuum line was switched on. The mixture was discharged after agitation for 1 hour.

The typical properties of this finished product were as below: viscosity at 40° C., 19,800 mPa·s; Gardner color 8; amine value, 293 mg KOH/g

### Example 4

Step 1: All synthesis process is the same as Step 1 in Example 1.

Step 2: 97 g of reaction product from Step 1 was charged into a flask and heated to 45° C. 3 g of vinylbenzyl chloride (VBC) was added in 20 minutes. A slightly exothermic effect was noted. The post reaction kept several hours to make sure all VBC was completely exhausted.

Step 3: 80 g of reaction product from Step 2 was charged and heated to 60° C. 20 g of silane 2 in methanol was added in 30 minutes. Then the mixture was discharged after agitation for 1 hour.

The typical properties of this finished product were as below: viscosity at 40° C., 31,289 mPa·s; Gardner color 9; amine value, 287 mg KOH/g.

### Example 5

Step 1: A 2000 mL four-neck round-bottom flask was equipped with a vacuum line, a dropping funnel, a nitrogen outlet, and a stirrer. Into the flask was charged 460 g of dimer acid and 225 g of Ancamine® 2655. The mixture was heated to 180 ºC under agitation to remove water. The temperature was elevated to 240° C. and the reaction went on for 2 hours. Water was removed. Then the pressure was reduced by switching on the vacuum line and stopping the purge of nitrogen. The content was cooled to 100° C. Into the mixture, 100 g of Exxsol™ D80 was charged. The mixture was stirred for 1 hour and then cooled to 70° C.

Step 2: 95 g of reaction product from Step 1 was charged into a flask and heated to 50° C., then 5 g of silane 2 in methanol was dropped within 30 minutes. The vacuum line was switched on. The mixture was discharged after agitation for 1 hour.

The typical properties of this finished product were as below: viscosity at 40° C., 17,350 mPa·s; Gardner color 8; amine value, 310 mg KOH/g.

### Example 6

Step 1: A 2000 mL four-neck round-bottom flask was equipped with a vacuum line, a dropping funnel, a nitrogen outlet, and a stirrer. Into the flask was charged 460 g of dimer acid and 240 g of tetraethylene pentaamine (TEPA). The mixture was heated to 180° C. under agitation to remove water. The temperature was elevated to 240° C. and the reaction went on for 2 hours. Water was removed. Then the pressure was reduced by switching on the vacuum line and stopping the purge of nitrogen. The content was cooled to 100° C. Into the mixture, 105 g of diisopropyl naphthalene (DINP) was charged. The mixture was stirred for 1 hour and then cooled to 70° C.

Step 2: 93 g of reaction product from Step 1 was charged into a flask and heated to 50° C., then 7 g of silane 3 was dropped within 30 minutes. The vacuum line was switched on. The mixture was discharged after agitation for 1 hour.

The typical properties of this finished product were as below: viscosity at 40° C., 17,890 mPa·s; Gardner color 8; amine value, 279 mg KOH/g.

### Example 7

Step 1: A 2000 mL four-neck round-bottom flask was equipped with a vacuum line, a dropping funnel, a nitrogen outlet, and a stirrer. Into the flask was charged 460 g of dimer acid, 102.1 g of Ancamine® 2655 and 115 g of triethylenetetramine (TETA). The mixture was heated to 180° C. under agitation to remove water. The temperature was elevated to 240° C. and the reaction went on for 2 hours. Water was removed. Then the pressure was reduced by switching on the vacuum line and stopping the purge of nitrogen. The content was cooled to 100° C. Into the mixture, 125 g of diisopropyl naphthalene (DINP) was charged. The mixture was stirred for 1 hour and then cooled to 70° C.

Step 2: 86 g of reaction product from Step 1 was charged into a flask and heated to 50° C., then 14 g of silane 3 was dropped within 30 minutes. The vacuum line was switched on. The mixture was discharged after agitation for 1 hour.

The typical properties of this finished product were as below: viscosity at 40° C., 21,080 mPa·s; Gardner color 9; amine value, 320 mg KOH/g.

### Testing

In order to evaluate improvement of adhesion to metal surface in PVC plastisol formulation, a PVC plastisol formulation was prepared as illustrated in the table below. The amidoamine composition as prepared in Examples 1 through 7 were used as adhesion promoter.

TABLE 1
PVC plastisol formulation

| Component | Function/composition | wt. (%) |
|---|---|---|
| Diisononylphthalate | Plasticizer | 22-30 |
| VESTOLIT ® P 1353K | PVC - homopolymer | 7.5 |
| Lacovyl ® PA 1384 | Vinyl chloride/vinyl | 5 |
| | acetate copolymer | |
| Vinnolit ® SA 1062/7 | Vinyl chloride/vinyl | 17.5 |
| | acetate copolymer | |
| Socal ® 312 | Coated chalk | 16 |
| Ulmer Weiss XM | Natural chalk | 16 |
| Aerosil ® 200 | Thixotropic agent | 0.5 |
| CaO | Drying agent | 2 |
| Zinc oxide | Stabilizer | 0.2 |
| Exxsol ™ D80 | Solvent | 4.3 |
| Products from Examples | Adhesion promoter | 0.5-8 |
| 1 through 7 | | |

The adhesion to metal was evaluated by tests with different baking circles and different load levels of the products from Examples 1 through 7 in the PVC plastisol. All the tests used six metal panels, in which four were made of different aluminum alloys and two were made of different steels. The baking circles differed in the temperature under which the PVC plastisol coated surfaces were baked. The temperatures used herein included 120° C., 130° C., 140° C., and 150° C. Duration of baking was 30 minutes. Load levels of the products were overall lower for adhesion test on steel panels and CED panels, as they are usually observed to be easier to adhere compared to those made of aluminum alloys.

Eight panels were used for demonstrating adhesion performances of PVC plastisol formulations with varying levels of adhesion promoter compositions. Four were made of aluminum alloys 6061, 5052, 3003, and 5083. Two were made of cathodic electrodeposition coated LS-800 (from Kansai Paint Co., Ltd.) and ES-27 (from Axalta Coating Systems). Two were made of cold-roll steel and 304 type carbon steel.

In the tables showing the test results, the different signs indicate different levels of adhesion.
− Poor adhesion;
+ Acceptable adhesion;
++ Excellent adhesion.

TABLE 2
Adhesion properties on panels made of different aluminum alloys

| | | Surface | Al alloy 6061 | | | Al alloy 5052 | | |
|---|---|---|---|---|---|---|---|---|
| Baking circle | | Load level (wt. %) | 0 | 2 | 5 | 0 | 2 | 5 |
| 120° | C. | Example 1 | − | − | − | − | − | − |
| 30 | minutes | Example 2 | − | + | − | − | + | − |
| | | Example 3 | − | − | + | − | − | + |
| | | Example 4 | − | + | − | − | + | − |
| | | Example 5 | − | − | + | − | − | + |
| | | Example 6 | − | + | + | − | + | + |
| | | Example 7 | − | + | + | − | + | + |
| 130° | C. | Example 1 | − | + | + | − | + | + |
| 30 | minutes | Example 2 | − | + | + | − | + | + |
| | | Example 3 | − | + | + | − | + | + |
| | | Example 4 | − | + | + | − | + | + |
| | | Example 5 | − | + | + | − | + | + |
| | | Example 6 | − | + | + | − | + | + |
| | | Example 7 | − | + | ++ | − | ++ | ++ |
| 140° | C. | Example 1 | − | ++ | ++ | − | ++ | ++ |
| 30 | minutes | Example 2 | − | ++ | ++ | − | ++ | ++ |
| | | Example 3 | − | ++ | ++ | − | ++ | ++ |
| | | Example 4 | − | ++ | ++ | − | ++ | ++ |
| | | Example 5 | − | ++ | ++ | − | ++ | ++ |
| | | Example 6 | − | ++ | ++ | − | ++ | ++ |
| | | Example 7 | − | ++ | ++ | − | ++ | ++ |
| 150° | C. | Example 1 | − | ++ | ++ | − | ++ | ++ |
| 30 | minutes | Example 2 | − | ++ | ++ | − | ++ | ++ |
| | | Example 3 | − | ++ | ++ | − | ++ | ++ |
| | | Example 4 | − | ++ | ++ | − | ++ | ++ |
| | | Example 5 | − | ++ | ++ | − | ++ | ++ |
| | | Example 6 | − | ++ | ++ | − | ++ | ++ |
| | | Example 7 | − | ++ | ++ | − | ++ | ++ |
| | | Surface | Al alloy 3003 | | | Al alloy 5083 | | |
| Baking circle | | Load level (wt. %) | 0 | 2 | 5 | 0 | 2 | 5 |
| 120° | C. | Example 1 | − | − | − | − | − | − |
| 30 | minutes | Example 2 | − | + | − | − | − | − |
| | | Example 3 | − | − | + | − | − | − |
| | | Example 4 | − | − | − | − | − | − |
| | | Example 5 | − | − | + | − | − | + |
| | | Example 6 | − | + | + | − | − | + |
| | | Example 7 | − | + | + | − | + | + |
| 130° | C. | Example 1 | − | + | + | − | − | − |
| 30 | minutes | Example 2 | − | + | + | − | − | − |
| | | Example 3 | − | + | + | − | − | − |
| | | Example 4 | − | + | + | − | − | − |
| | | Example 5 | − | + | + | − | − | − |
| | | Example 6 | − | + | + | − | + | + |
| | | Example 7 | − | ++ | ++ | − | + | + |
| 140° | C. | Example 1 | − | ++ | ++ | − | + | + |
| 30 | minutes | Example 2 | − | ++ | ++ | − | + | + |
| | | Example 3 | − | ++ | ++ | − | + | + |
| | | Example 4 | − | ++ | ++ | − | + | + |
| | | Example 5 | − | ++ | ++ | − | + | + |
| | | Example 6 | − | ++ | ++ | − | ++ | ++ |
| | | Example 7 | − | ++ | ++ | − | ++ | ++ |
| 150° | C. | Example 1 | − | ++ | ++ | − | + | ++ |
| 30 | minutes | Example 2 | − | ++ | ++ | − | + | + |
| | | Example 3 | − | ++ | ++ | − | + | ++ |
| | | Example 4 | − | ++ | ++ | − | + | + |
| | | Example 5 | − | ++ | ++ | − | + | ++ |
| | | Example 6 | − | ++ | ++ | − | + | ++ |
| | | Example 7 | − | ++ | ++ | − | + | ++ |

It is observed from the above tables, adhesion improves with increasing baking temperature from 120° C. to 140° C.

It is also observed from the above tables, adhesion improves with increasing load level from 2% to 5% of the adhesion promoter in PVC plastisol.

It is observed that products from Example 6 and Example 7 could have good adhesion to all different aluminum alloy surfaces tested regardless of baking circles and load levels, compared to other products from Examples 1 through 5.

TABLE 3
Adhesion properties on panels made of two different
electrode deposition primer metals

| | | Surface | CED LS-800 | | | CED ES-27 | | |
|---|---|---|---|---|---|---|---|---|
| Baking circle | | Load level (wt. %) | 0 | 0.5 | 1 | 0 | 0.5 | 1 |
| 120° | C. | Example 1 | − | ++ | ++ | − | ++ | ++ |
| 30 | minutes | Example 2 | − | ++ | ++ | − | ++ | ++ |
| | | Example 3 | − | ++ | ++ | − | ++ | ++ |
| | | Example 4 | − | ++ | ++ | − | ++ | ++ |
| | | Example 5 | − | ++ | ++ | − | ++ | ++ |
| | | Example 6 | − | ++ | ++ | − | ++ | ++ |
| | | Example 7 | − | ++ | ++ | − | ++ | ++ |
| 130° | C. | Example 1 | − | ++ | ++ | − | ++ | ++ |
| 30 | minutes | Example 2 | − | ++ | ++ | − | ++ | ++ |
| | | Example 3 | − | ++ | ++ | − | ++ | ++ |
| | | Example 4 | − | ++ | ++ | − | ++ | ++ |
| | | Example 5 | − | ++ | ++ | − | ++ | ++ |
| | | Example 6 | − | ++ | ++ | − | ++ | ++ |
| | | Example 7 | − | ++ | ++ | − | ++ | ++ |
| 140° | C. | Example 1 | − | ++ | ++ | − | ++ | ++ |
| 30 | minutes | Example 2 | − | ++ | ++ | − | ++ | ++ |
| | | Example 3 | − | ++ | ++ | − | ++ | ++ |
| | | Example 4 | − | ++ | ++ | − | ++ | ++ |
| | | Example 5 | − | ++ | ++ | − | ++ | ++ |
| | | Example 6 | − | ++ | ++ | − | ++ | ++ |
| | | Example 7 | − | ++ | ++ | − | ++ | ++ |
| 150° | C. | Example 1 | − | ++ | ++ | − | ++ | ++ |
| 30 | minutes | Example 2 | − | ++ | ++ | − | ++ | ++ |
| | | Example 3 | − | ++ | ++ | − | ++ | ++ |
| | | Example 4 | − | ++ | ++ | − | ++ | ++ |
| | | Example 5 | − | ++ | ++ | − | ++ | ++ |
| | | Example 6 | − | ++ | ++ | − | ++ | ++ |
| | | Example 7 | − | ++ | ++ | − | ++ | ++ |

After baking circles with a baking temperature ranging from 120° C. to 150° C., all the products from Examples 1 through 7 produced excellent adhesion on two different CED panels at quite low load levels in PVC plastisol from 0.5 wt. % to 1 wt. %.

TABLE 4
Adhesion properties on panels made of steel and carbon steel

| | | Surface | Steel | | | Carbon steel | | |
|---|---|---|---|---|---|---|---|---|
| Baking circle | | Load level (wt. %) | 0 | 1 | 3 | 0 | 1 | 3 |
| 120° | C. | Example 1 | − | + | + | − | + | + |
| 30 | minutes | Example 2 | − | − | + | − | − | − |
| | | Example 3 | − | + | + | − | − | − |
| | | Example 4 | − | − | + | − | − | + |
| | | Example 5 | − | − | + | − | − | − |
| | | Example 6 | − | + | + | − | + | + |
| | | Example 7 | − | + | + | − | + | + |
| 130° | C. | Example 1 | − | + | ++ | − | + | + |
| 30 | minutes | Example 2 | − | − | + | − | − | + |
| | | Example 3 | − | + | ++ | − | + | + |
| | | Example 4 | − | + | + | − | + | + |
| | | Example 5 | − | + | ++ | − | + | + |
| | | Example 6 | − | + | ++ | − | + | ++ |
| | | Example 7 | − | + | ++ | − | + | ++ |
| 140° | C. | Example 1 | − | + | ++ | − | + | + |
| 30 | minutes | Example 2 | − | + | ++ | − | + | + |
| | | Example 3 | − | + | ++ | − | + | + |
| | | Example 4 | − | + | ++ | − | + | + |
| | | Example 5 | − | + | ++ | − | + | + |
| | | Example 6 | − | ++ | + | − | ++ | ++ |
| | | Example 7 | − | ++ | ++ | − | ++ | ++ |
| 150° | C. | Example 1 | − | + | ++ | − | + | + |
| 30 | minutes | Example 2 | − | + | ++ | − | + | + |
| | | Example 3 | − | + | ++ | − | + | + |
| | | Example 4 | − | + | ++ | − | + | + |
| | | Example 5 | − | + | ++ | − | + | + |
| | | Example 6 | − | ++ | ++ | − | ++ | ++ |
| | | Example 7 | − | ++ | ++ | − | ++ | ++ |

According to Table 4, carbon steel showed slightly weaker adhesion to the PVC plastisol formulations compared to steel at low load level under a baking temperature of 120° C. Products from Example 6 and 7 showed excellent bond to the substrate even at a low load level of 0.5 wt. %. As baking temperature exceeded 130° C., all the products from Examples 1 through 7 could produce acceptable adhesion on substrates made of the two steels.

Various aspects and embodiments are possible. Some of those aspects and embodiments are described herein. After reading this specification, skilled artisans will appreciate that those aspects and embodiments are only illustrative and do not limit the scope of the present disclosure. Embodiments could be in accordance with any one or more of the embodiments as listed below.

The above description is presented to enable a person skilled in the art to make and use the present disclosure and is provided in the context of an application and its requirements. Various modifications to the preferred embodiments will be apparent to those skilled in the art, and the generic principles defined herein might be applied to other embodiments and applications without departing from the spirit and scope of the present disclosure. Thus, the present disclosure is not intended to be limited to the embodiments shown but is to be accorded the widest scope consistent with the principles and features disclosed herein. In this regard, certain embodiments within the present disclosure might not show every benefit of the present disclosure, considered broadly.

1. An amidoamine composition comprising:
i) an amidoamine with
a) at least one amide group or at least one imide group; and
b) at least one amino group; and
ii) one or more silanes selected from the group consisting of:
c) an ammonium salt of an aminosilane, the aminosilane being represented by formula (I): 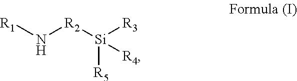
d) a mercaptosilane represented by formula (II): 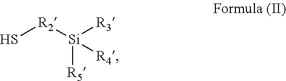
wherein, R₁ is a hydrogen atom, an alkyl group, a substituted alkyl group, an aryl group, or a substituted aryl group; R₂ and R₂′ are independently an aliphatic chain with at least one carbon atom; R₃, R₃′, R₄, R₄′, R₅, and R₅′ are independently a hydrocarbon radical with 1 to 20 carbon atoms, an alkoxy group with 1 to 20 carbon atoms, or an aryloxy group with 6 to 20 carbon atoms.

2. The amidoamine composition of claim 1, wherein R₁ has at least one nitrogen atom in the form of —NH₂, —NHR₆, or —NR₇R₈, wherein R₆, R₇, and R₅ are independently an alkyl group, a substituted alkyl group, an aryl group, or a substituted aryl group.

3. The amidoamine composition of claim 1, wherein R₃, R₃′, R₄, R₄′, R₅, and R₅′ are independently selected from methyl, ethyl, propyl, butyl, methoxy, ethoxy, propoxy, butoxy, or 2-(2-butoxyethoxy)ethoxy.

4. The amidoamine composition of claim 1, wherein the amidoamine is a reaction product of a) one or more carboxylic acids and b) one or more amines with at least two amino groups.

5. The amidoamine composition of claim 4, wherein the carboxylic acids include a dicarboxylic acid.

6. The amidoamine composition of claim 4, wherein the amines include one or more polyalkylenepolyamines.

7. The amidoamine composition of claim 1, wherein the amidoamine is a reaction product of a) one or more amines having a terminal primary amino group and b) one or more copolymers of an alpha-olefin and an unsaturated carboxylic anhydride.

8. The amidoamine composition of claim 7, wherein the amines are selected from aminomethylpiperazine, aminoethylpiperazine, aminopropylpiperazine, aminomethylimidazolidine, aminoethylimidazolidine, aminopropylimidazolidine, dimethylaminopropylamine, or dimethylaminopropylaminopropylamine.

9. The amidoamine composition of claim 7, wherein the alpha-olefin is an alpha-olefin having 2 to 20 carbon atoms.

10. The amidoamine composition of claim 7, wherein the unsaturated carboxylic anhydride is selected from maleic anhydride, itaconic anhydride, or citraconic anhydride.

11. The amidoamine composition of claim 1, further comprising an organic chloride.

12. An adhesive composition comprising:
i) an amidoamine composition according to claim 1; and
ii) a curable polymeric composition.

13. The adhesive composition of claim 12, wherein the curable polymeric composition includes poly(vinyl chloride) or a vinyl chloride copolymer.

14. The adhesive composition of claim 12, wherein the curable polymeric composition includes an epoxy polymer.

15. The adhesive composition of claim 12, further comprising a plasticizer.

16. The adhesive composition of claim 12, further comprising one or more additives selected from fillers, reinforcing agents, adhesion promoters, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, anti-dripping agents, stabilizers, metal glitters, metal coated particles, porosity inducers, glass fibers, nanoparticles, flow assistants, or combinations thereof.

17. The adhesive composition of claim 16, wherein the additive has a weight percentage of less than 90%, based on a total weight of the adhesive composition.

18. The adhesive composition of claim 12, wherein the amidoamine composition has a weight percentage of less than 10%, based on a total weight of the adhesive composition.

19. The adhesive composition of claim 18, wherein the amidoamine composition has a weight percentage of more than 0.5% and less than 8%, based on a total weight of the adhesive composition.

20. A method for preparing an amidoamine composition of claim 1, comprising:
i) providing an amidoamine with
a) at least one amide group and
b) at least one amino group;
ii) providing one or more silanes selected from a group consisting of:
c) an ammonium salt of an aminosilane, the aminosilane being represented by formula (I); 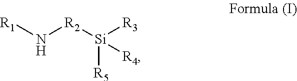
and
d) a mercaptosilane represented by formula (II): 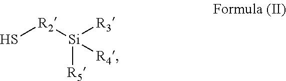
and
iii) mixing the amidoamine and the one or more silanes and forming the amidoamine composition,
wherein, R₁ is a hydrogen atom, an alkyl group, a substituted alkyl group, an aryl group, or a substituted aryl group; R₂ and R₂′ are independently an aliphatic chain with at least one carbon atom; R₃, R₃′, R₄, R₄′, R₅, and R₅′ are independently a hydrocarbon radical with 1 to 20 carbon atoms, an alkoxy group with 1 to 20 carbon atoms, or an aryloxy group with 6 to 20 carbon atoms.
